(19) United States
(12) Patent Application Publication
(10) Pub. No.: US 2017/0361470 A1
(43) Pub. Date: Dec. 21, 2017

(54) ROBOTIC SYSTEM FOR CONFINED SPACE OPERATIONS

(71) Applicant: ANSALDO ENERGIA IP UK LIMITED, London (GB)

(72) Inventors: Elena OTERO DEL REAL, Zürich (CH); Wolfgang FISCHER, Zürich (CH); Edgar Ernesto CARRASCO, Münchenstein (CH); Christoph HUERZELER, Wallisellen (CH); Andres PERALTA, Dättwil (CH); Dominil LOOSLI, Zürich (CH); Thomas SCHNEIDER, Baden (CH); Thomas MORRIS, Baden (CH)

(73) Assignee: ANSALDO ENERGIA IP UK LIMITED, London (GB)

(21) Appl. No.: 15/629,009

(22) Filed: Jun. 21, 2017

(30) Foreign Application Priority Data
Jun. 21, 2016 (EP) 16175502.0

(51) Int. Cl. B25J 18/06; B25J 18/02; B25J 19/02

(52) U.S. Cl. CPC B25J 18/06; B25J 19/023; B25J 18/02; Y10S 901/44

(57) ABSTRACT

A robotic system includes a main drive unit, a non-actuated extendable arm unit an axial drive unit, an arm guidance member, and a head articulation unit. The unit includes a mounting structure, and an arm storage unit coupled to the mounting structure. The arm unit is coupled to the arm storage unit to be moved axially in a lateral plane from the arm storage unit. The arm unit is flexible and thin in the lateral plane, and rigid and wide in a vertical plane. The unit may be coupled to the arm storage unit to enable axial extension and retraction of the unit. The head articulation unit is coupled to the arm unit to actuate thereto.

### PRIORITY CLAIM

This application claims priority from European Patent Application No. 16175502.0 filed on Jun. 21, 2016, the disclosure of which is incorporated by reference.

### BACKGROUND

### Field of Endeavor

The present disclosure relates generally to robotics and, more particularly, to a robotic device or system including robotic arms for an environment, including but not limited to, confined and complex geometries, e.g. given by pipework or turbine flow-paths in a power plant, for applications, such as, inspection, manipulation, and in-situ repair.

### Brief Description of the Related Art

Robotic devices have been successfully utilized in many different applications, such as machining, assembly, inspection, repair and more. In spite of all of that, it has always been challenging to bring such devices into complex and confined geometries or environments. Conventional robotic devices may have the capability of accommodating various useful operations in non-confined geometries or environments but there is an on-going need for improved tools that may easily adapt to applications in confined and complex spaces.

In the context of industrial applications, robotic systems are a quite popular choice for inspection, repair or other manipulation tasks. For example, U.S. Pat. No. 8,374,722 B2 discloses a robotic arm to inspect rotary machines such as a gas turbine engines. The arm has a plurality of groups of links having articulations therebetween for movement in a first plane, the groups having articulations with respect to each other for movement in a second plane. At the distal end of the arm a spatial tip section is installed comprised of a series of elements articulated for movement about both planes so as to be able to move in a snake-like manner. The actuated arm can move around objects such as airfoils in the engine, and also move up or down to remain close to the rotary surface of the machine. However, the device requires a complex actuation, sensing and control system to achieve the targeted manipulation tasks. This limits payload capabilities for an end-tool, achievable robustness as well as the minimal achievable dimensions for operations in confined space. In addition, highly trained operators are required for safe operation of the manipulation arm.

In another WO Patent Application Number WO 0216995, a robotic arm comprising a plurality of longitudinal segments, each of which is connected by a plurality links, is described. The end of each segment is “guided” by wires or thin sheets so that by varying the length of the wires, the arm can be actuated and bent. By adjusting the tension in the control wires for each segment, the arm can move and adopt various spatial shapes and configurations. This may be done for example by winding each control wire on or off a spindle using a motor. The motors are controlled for example by a computer control system. Similar to the system described in U.S. Pat. No. 8,374,722 B2, a complex actuation, sensing and control system is necessary to achieve the desired operations in confined spaces.

While there are a number of other related prior arts directed towards the continuous improvement of robotic inspection and repair systems, there is a great need for new platforms which perform more and more complex operations within continuously smaller and more complex confined spaces (e.g. more and more complex and curved flow paths in gas turbines). This requirement goes hand in hand with ever increasing requirements for payload capacity, operation speed, simplicity and robustness.

### SUMMARY

This summary will present a simplified overview of the present disclosure in order to provide a basic understanding. It is not intended to either identify key or critical elements of the disclosure or to delineate the scope of the present invention. Rather, the sole purpose of this summary is to present general aspects and concepts of the disclosure as well as its advantages as a prelude to the more detailed description that is provided hereafter.

A general object of the present disclosure is to provide the means to transport an end-tool along complex and confined geometries or environments for applications such inspection, maintenance, repair and other related operations. The general object of the invention is to provide a system which can bring increased payloads into complex, confined structures in a faster, simpler and more robust manner.

In one aspect of the present disclosure, a robotic system for operations, such as measurement and manipulation tasks in confined spaces and environments is provided. The robotic system disclosed herein may include a main drive unit, a non-actuated extendable arm unit, an axial drive, an arm guidance member and a head articulation unit. The main drive unit may include a mounting structure and an arm storage unit coupled to the mounting structure. Further, the non-actuated extendable arm unit may be coupled to the arm storage unit to be moved axially in a predefined direction in the lateral plane from the arm storage unit. The non-actuated extendable arm unit may include an elongated structure, flexible and thin in the lateral to plane, and rigid and wide in a vertical plane. This extendable arm unit is non-actuated but constructed in a ways to exhibit spring like characteristics in its longitudinal direction. Consequently, it is the shape of the confined space environment which defines the shape of the extendable arm unit. Furthermore, the axial drive unit may be coupled to the arm storage unit to enable axial extension and retraction of the non-actuated extendable arm unit from the arm storage unit. The arm guidance member may be coupled to the arm storage unit to guide the non-actuated extendable arm unit in a predefined direction in the lateral plane during extension and retraction. Moreover, the head articulation unit may be coupled to a free end of the non-actuated extendable arm unit to actuate and move the non-actuated extendable arm unit in varying directions within confined spaces and environments in a “follow-the-leader” manner.

In one embodiment, the mounting structure may include a plurality of plates and poles arranged in relation to each other to form first and second levels within the main drive unit to accommodate the arm storage unit extending across the first and second levels. Further, the axial drive unit, as per this embodiment, is disposed in the second level of the mounting structure to enable the non-actuated extendable arm unit to axially extend and contract from the arm storage unit along the direction defined by the arm guidance member. The axial drive unit includes an axial drive motor; and an axial drive tower pinion and spring arrangement driven by the axial drive motor to axially extend and retract the extendable arm. It also includes an arm attachment coupled to the axial drive tower pinion and spring arrangement to axially guide the non-actuated extendable arm unit. Furthermore, the arm guidance member of this embodiment is coupled to the plates along the first level to guide the non-actuated extendable arm unit in a predefined direction in the lateral plane during axial extension and retraction of the non-actuated extendable arm unit from the arm storage unit with respect to the mounting structure. Moreover, the non-actuated extendable arm unit of this embodiment may include an elongated structure and a plurality of wire guides. The elongated structure includes a pair of flat flexible sheet elements disposed spaced-apart from each other in the vertical plane. Further, the plurality of wire guides positioned within the spaced pair of flat flexible sheet elements are also spaced in the vertical plane. This construction forms the non-actuated extendable arm unit which is flexible and thin in the lateral plane, and rigid and wide in a vertical plane. In addition, the structure as such exhibits spring-like characteristics along its longitudinal axis. Consequently, this embodiment of the extendable arm unit can be pushed into a predefined shape of an external infrastructure from the arm storage unit by naturally adapting its own shape in the lateral plane, while maintaining an axially directed force. As such, the main purpose of the extendable arm is transmitting the push force from the axial drive to the head articulation while adapting its shape to the given confined space.

The head articulation unit may include a flexible body extending between opposite ends, the flexible body having an interface end coupled to a free end of the extendable arm unit and a plurality of wires guides to couple the head articulation unit with a motor positioned/located within the main drive unit.

In another embodiment, the mounting structure may include a plurality of plates arranged in relation to each other to form first and second levels within the main drive unit to accommodate the arm storage unit in the first levels and casing arrangement covering the first and second levels. Further, the arm guidance member, as per this embodiment, may be coupled to the plates along the first level to guide the non-actuated extendable arm unit in a predefined direction in the lateral plane while axially extending or retracting non-actuated extendable arm unit from the arm storage unit. Furthermore, the axial drive unit may be coupled to plates outside of the mounting structure and extend in the mounting structure along the first level to enable the non-actuated extendable arm unit to axially extend and retract from the arm storage unit along the direction defined by the arm guidance member.

The axial drive unit as per this embodiment may include an axial drive motor, an axial drive gear and belt arrangement, and an arm attachment. The axial drive gear and belt arrangement may be driven by the axial drive motor. Further, the arm attachment may be coupled to the axial drive gear and belt arrangement to axially push or pull the non-actuated extendable arm unit. The arm attachment may be coupled to the non-actuated extendable arm unit. Further, the arm guidance member may be coupled along a side portion of the first level to guide the non-actuated extendable arm unit in a predefined direction in the lateral plane during axial extension and retraction of the non-actuated extendable arm unit from the arm storage unit with respect to the mounting structure. Furthermore, the non-actuated extendable arm unit may include a flexible sheet (such as e.g. spring steel) orientated in the vertical plane and a plurality of mechanical segments connected by mechanical joints, connected in series along the lateral side edges of the flexible sheet, effectively embedding the sheet within. The flexible sheet of the non-actuated extendable arm unit exhibits the necessary spring characteristics along the extendable arm's longitudinal axis to allow a payload to be pushed into the predefined shape of an external infrastructure while passively adapting the arm's shape in the lateral plane. In this context, the segmented joint structure encapsulating the sheet enables the required mechanical robustness and rigidity to support heavy payloads during insertion.

Finally, in this alternative embodiment, the head articulation unit may include a steering chain arrangement, having an interface end coupled to a free end of the extendable arm unit, a steering motor coupled to the steering chain arrangement, and a head roll joint coupled to the steering chain arrangement. In this embodiment, the head-roll joint enables an additional rotational degree of freedom aligned with the longitudinal axis of the extendable arm. It creates additional structural flexibility for this second more rigid embodiment of the non-actuated extendable arm unit which is inherent in the first, described embodiment. This rotational flexibility of the head articulation unit is expected to benefit applications where an end-tool needs to align with the orientation of different components in the confined space infrastructure.

The robotic system may further include a carrier platform to mount the main drive unit thereon to move the main drive unit along a predefined path. The carrier platform may include a carrier plate, a driving motor, and a guidance member. The carrier plate may be adapted to mount the main drive unit thereon. The driving motor may be coupled to the carrier plate to drive the carrier platform. The guidance member is coupled to the carrier plate to guide the main drive unit along the predefined path.

In one embodiment, the robotic system may further include an end tool attached to the head articulation unit. The end tool, in an example, may be an exchangeable inspection scanner. The exchangeable inspection scanner may include a spreading mechanism coupled to the head articulation unit, a back skid coupled to the spreading mechanism at one side, a probe holder having at least one probe, the probe holder coupled to the spreading mechanism on other side opposite to the back skid and a linear guidance coupled to the probe holder to guide the probe holder and probes. In another example, the end tool may be an exchangeable camera system. The camera system may be mounted to the head articulation unit for the purpose of visual inspection. An interface may be provided for the camera system to be coupled to the head articulation unit.

In one embodiment, the mounting structure may further includes a plurality of electronic components mounted on the mounting structure to enable operations including at least an electric power distribution, sensor data acquisition, motor control function, communication between a plurality of devices.

The term “non-actuated” used herein, such as “non-actuated extendable arm unit” means the extended arm unit is not self-actuated but requires a suitable means as described herein to be actuated. For a better understanding of the various aspects of the present disclosure, its operating advantages, and its uses, reference now should be made to the accompanying exemplary drawings.

### BRIEF DESCRIPTION OF THE DRAWINGS

The features and advantages of the present disclosure will be better understood with reference to the following description of a non-exclusive device embodiment, in conjunction with the accompanying drawings in which:

FIGS. 1A, 1B and 1C illustrate a robotic system, in accordance with one exemplary embodiment of the present disclosure;

FIGS. 2A, 2B and 2C illustrate a robotic system, in accordance with another exemplary embodiment of the present disclosure;

FIGS. 3A and 3B illustrate a main drive unit of the robotic system of FIGS. 1A-1C, in accordance with first exemplary embodiment of the present disclosure;

FIGS. 4A and 4B illustrate an extendable arm unit of the robotic system of FIGS. 1A-1C, in accordance with first exemplary embodiment of the present disclosure;

FIG. 5A and 5B illustrates an axial drive unit of the robotic system of FIGS. 1A-1C, in accordance with first exemplary embodiment of the present disclosure;

FIG. 6A-6E illustrate a head articulation unit of the robotic system of FIGS. 1A-1C, in accordance with first exemplary embodiment of the present disclosure;

FIGS. 7A and 7B illustrate a main drive unit of the robotic system of FIGS. 2A-2C, in accordance with second exemplary embodiment of the present disclosure;

FIGS. 8A and 8B illustrate an extendable arm unit of the robotic system of FIGS. 2A-2C, in accordance with second exemplary embodiment of the present disclosure;

FIGS. 9A and 9B illustrate an axial drive unit of the robotic system of FIGS. 2A-2C, in accordance with second exemplary embodiment of the present disclosure;

FIGS. 10A and 10B illustrate a head articulation unit of the robotic system of FIGS. 2A-2C, in accordance with second exemplary embodiment of the present disclosure;

FIGS. 11A and 11B illustrate end tool, in accordance with an exemplary embodiment of the present disclosure;

FIGS. 12A and 12B illustrate a carrier platform, in accordance with an exemplary embodiment of the present disclosure; and

FIGS. 13A and 13B illustrate an example environment where the robotic system may be utilized for purposes, such as inspection, manipulation or repair.

Like reference numerals refer to like parts throughout the description of several views of the drawings.

### DETAILED DESCRIPTION OF EXEMPLARY EMBODIMENTS

For a thorough understanding of the present disclosure, reference is to be made to the following detailed description, including the appended claims, in connection with the above-described drawings. In the following description, for purposes of explanation, numerous specific details are set forth in order to provide a thorough understanding of the present disclosure. It will be apparent, however, to one skilled in the art, that the present disclosure can be practiced without these specific details. In other instances, structures and devices are shown in block diagram form only, in order to avoid obscuring the disclosure. Reference in this specification to “one embodiment,” “an embodiment,” “another embodiment,” “various embodiments,” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but may not be of other embodiment's requirement.

Although the following description contains many specifics for the purposes of illustration, anyone skilled in the art will appreciate that many variations and/or alterations to these details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure. Further, the relative terms used herein do not denote any order, elevation or importance, but rather are used to distinguish one element from another. Further, the terms “a,” “an,” and “plurality” herein do not denote a limitation of quantity, but rather denote the presence of at least one of the referenced item.

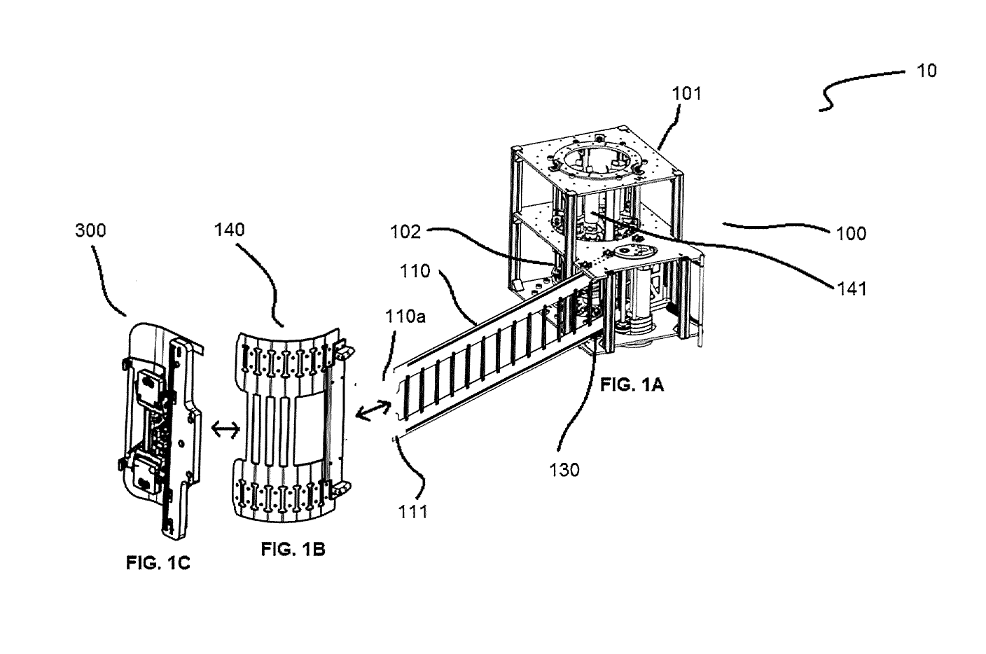

Referring to FIGS. 1A to 13B, various embodiments and components of a robotic system 100 are depicted in accordance with various exemplary embodiments of the present disclosure. The robotic system 10 may be utilized in various environments, for application including, but not limited to, inspection, manipulation and repair.

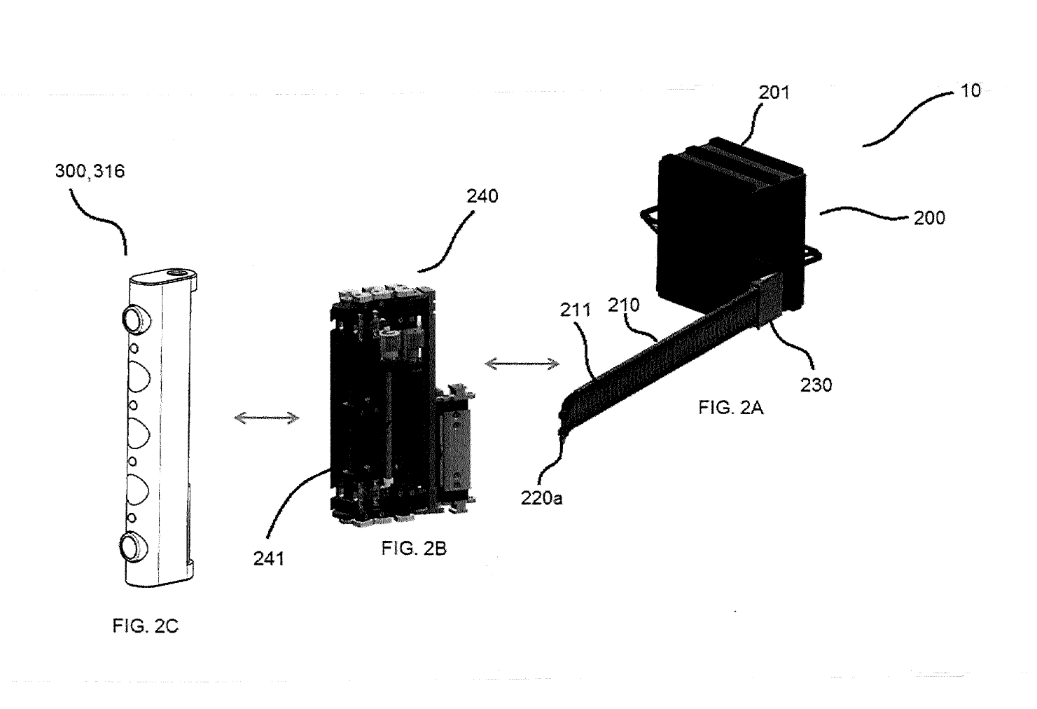

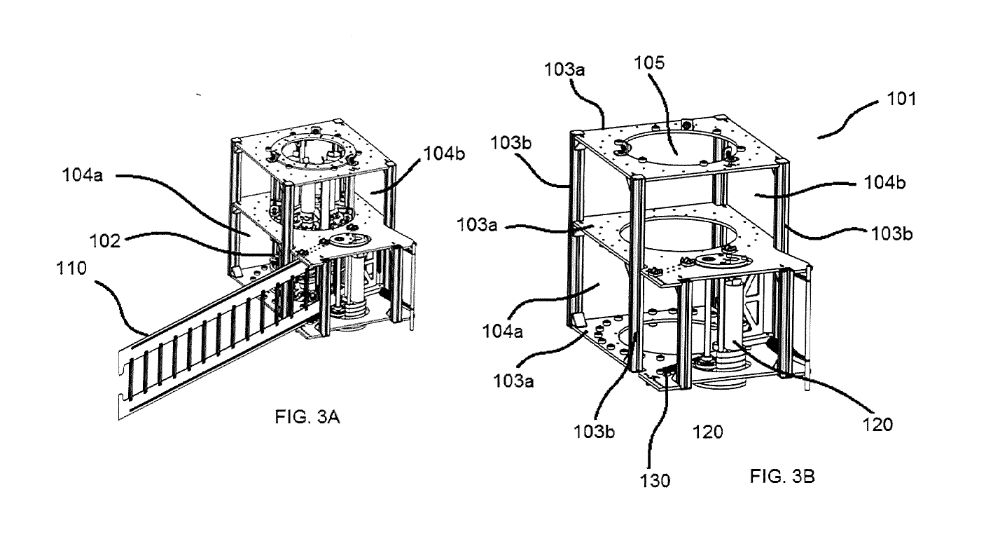

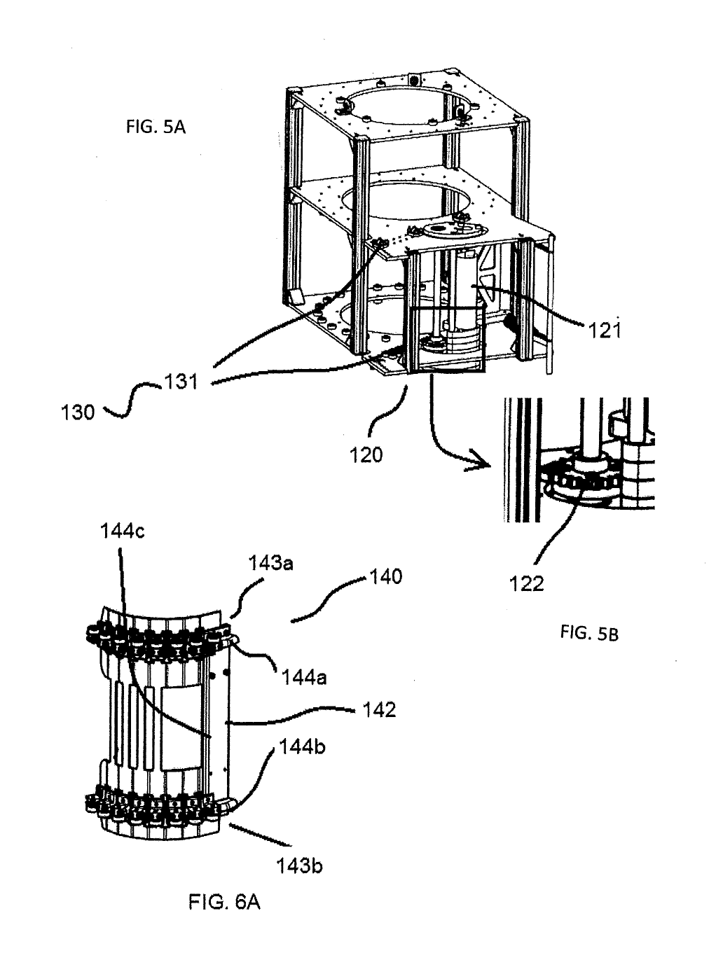

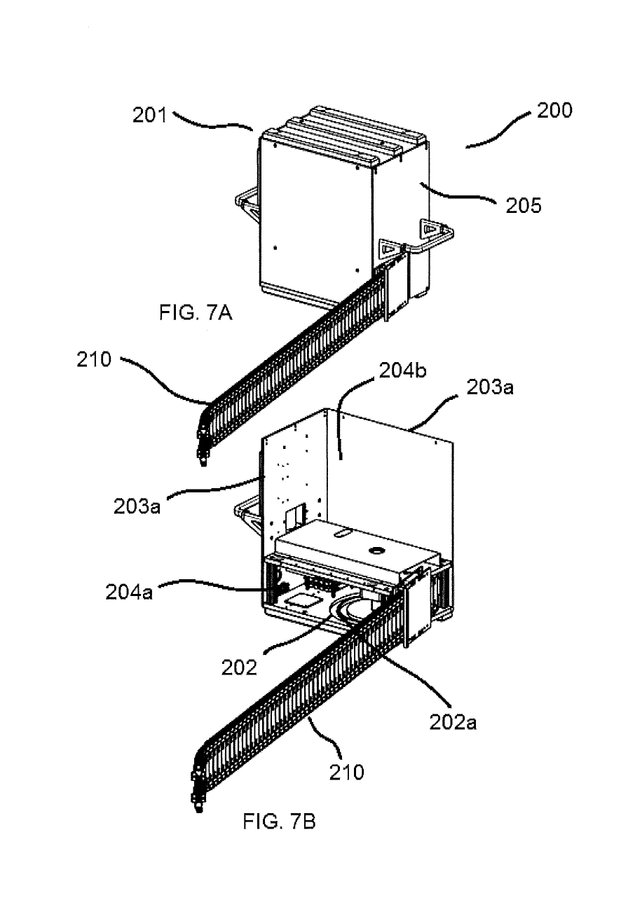

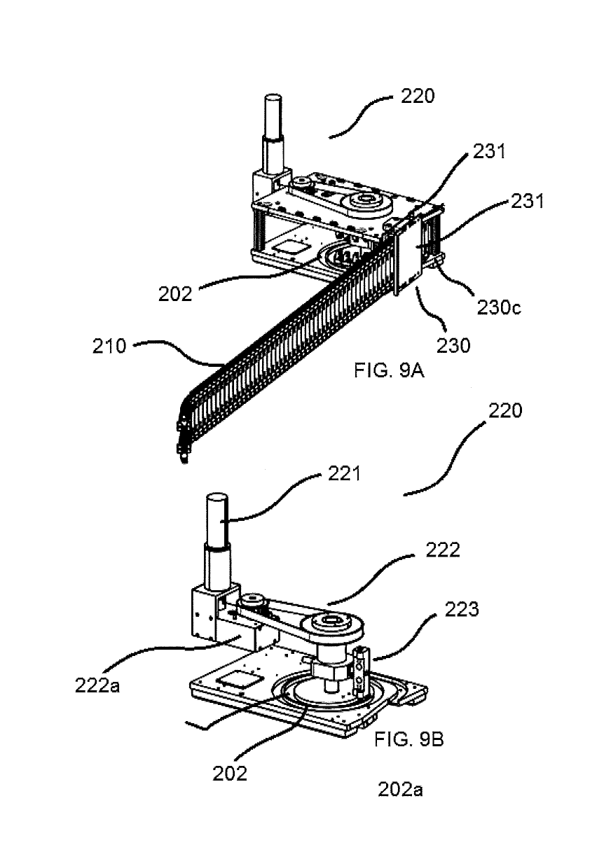

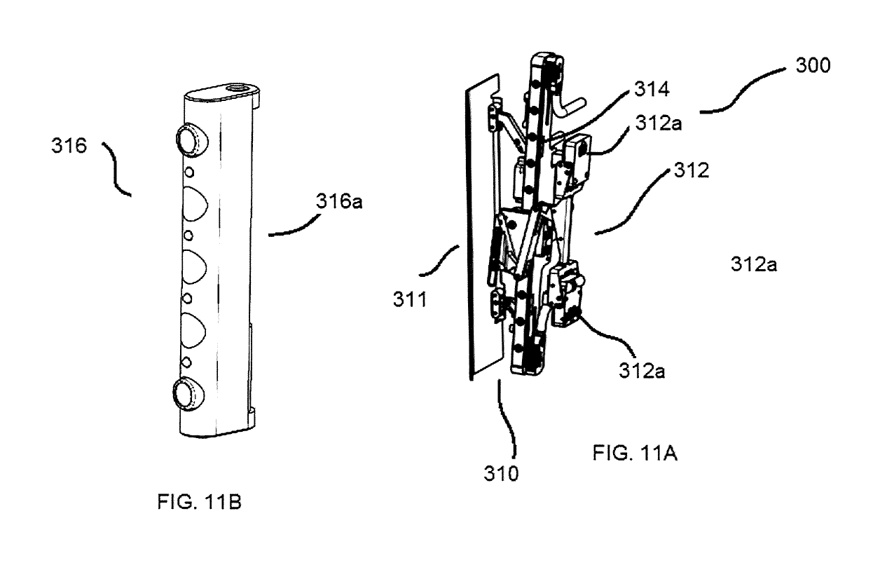

FIGS. 1A to 2C broadly depict a robotic system 10 in accordance with various embodiments of the present disclosure. The robotic system 10 includes a main drive unit 100, 200, a non-actuated extendable arm unit 110, 210, an axial drive unit 120, 210 (shown in FIGS. 5A and 9A-9B), an arm guidance member 130, 230, and a head articulation unit 140, 240. The main drive unit 100, 200 may include a mounting structure 101, 201, and an arm storage unit 102, 202 (shown in FIGS. 3A and 7B) coupled to the mounting structure 101, 201. Further, the non-actuated extendable arm unit 110, 210 may be coupled to the arm storage unit 102, 202 to be moved axially in a predefined direction in a lateral plane from the arm storage unit 102, 202. The non-actuated extendable arm unit 110, 210 may include an elongated structure 111, 211 flexible and thin in the lateral plane, and rigid and wide in a vertical plane. Furthermore, the axial drive unit 120, 220 may be coupled to the arm storage unit 102, 202 to enable axial extension and retraction of the non-actuated extendable arm unit 110, 220 from the arm storage unit 102, 202. The arm guidance member 130, 230 may be coupled to the arm storage unit 102, 202 to guide the non-actuated extendable aim unit 110, 220 in a predefined direction in the lateral plane during extension and retraction. Moreover, the head articulation unit 140, 240 may be coupled to a free end 110a, 210a of the non-actuated extendable arm unit 110, 220 to actuate and move the non-actuated extendable arm unit 110, 220 in varying directions in the confined spaces and environments. To actuate the head articulation unit 140, 240, head articulation motors 141, 241 may be configured selectively on the mounting structure 101 or within the head articulation unit 240 itself. Moreover, end tools may be coupled to the head articulation unit 140, 240 and will be described with reference to FIGS. 11A and 11B.

Referring now to FIGS. 3A to 6E, as per one embodiment of the present disclosure, the robotic system 10 will be described in detail. In FIGS. 3A and 3B, the main drive unit 100, having the mounting structure 101 and the arm storage unit 102 coupled to the mounting structure 101 is depicted. The mounting structure 101 may include a plurality of plates 103a and poles 103b arranged in relation to each other to form first and second levels 104a, 104b within the main drive unit 103 to accommodate the arm storage unit 102 which extends across the first and second levels 103a, 103b. As depicted in example FIGS. 3A and 3B, three plates 103a are horizontally disposed one above other in spaced manner and supported by poles 103b which are disposed along the corners of the plates 103a to obtain a rigid mounting structure 101. The first level 104a of the mounting structure 101 is obtained between the above two plates 103a, and the second level 104b of the mounting structure 101 is obtained between the below two plates 103a, middle plate 103a being common to both the first 104a and second 104b levels. Further, each plate 102a may include an opening 105 that is axially aligned with the openings of the other plates. The axially aligned openings 105 may be capable of rotatably accommodating the arm storage unit 102 extending in the first 104a and second 104b levels. In an example form, the arm storage unit 102 may be a rotatable drum aligned and extending along the first and second levels 104a, 104b of the mounting structure 101.

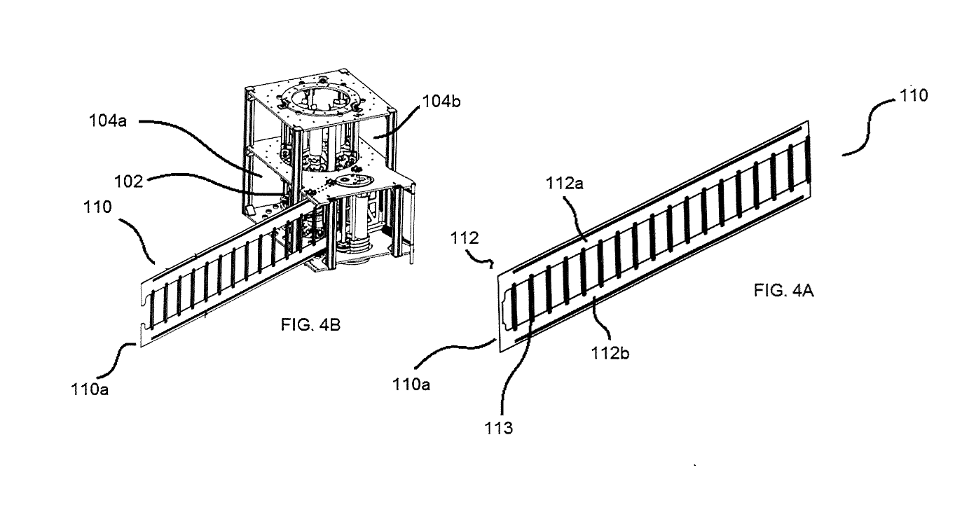

As depicted in FIGS. 4A, 4B and 5A and 5B, and described in conjunction with FIGS. 1A-1C and 3A-3B, the axial drive unit 120 and the non-actuated extendable arm unit 110 (hereinafter will be referred to as ‘arm unit 110’) as per this embodiment may be disposed in the first level 104b of the mounting structure 101 to enable the arm unit 110 to axially extend and contract from the arm storage unit 102 along the direction defined by the arm guidance member 130. Further, the arm guidance member 130 (hereinafter referred to as ‘guidance member 130’) of this embodiment may be coupled to the plates 103a along the first level 104a to guide the arm unit 110 in the lateral plane during axial extension and retraction of the arm unit 110 from the arm storage unit 102 with respect to the mounting structure 101. The axial drive unit 120, guidance member 130 and the non-actuated arm unit 110 of the present embodiment will be described with reference to example FIGS. 4A-4B and 5A-5B.

The axial drive unit 120 includes an axial drive motor 121, an axial drive tower pinion and spring arrangement 122 (hereinafter will be referred to as ‘drive tower 122’) and an arm attachment 123. The drive tower 122 is driven by the axial drive motor 121 to axially expand and contract the arm unit 110. The arm attachment 123 is coupled to the drive tower 122 to axially guide the arm unit 110.

The arm guidance member 130 may be coupled to the plates 103a of the first level 104a to guide the arm unit 110 in a predefined direction in the lateral plane during axial extension and retraction of the arm unit 110 from the arm storage unit 102 with respect to the mounting structure 101. The arm guidance member 130 may include a set of rollers 131 configured on both of the plates 103a of the first level 104a through which the arm unit 110 may pass and be guided therebetween to enable axial expansion and contraction of the arm unit 110.

Further, the arm unit 110 may include an elongated structure 112 having a pair of flat flexible sheet elements 112a, 112b (hereinafter “sheet 112a/112b”) disposed spaced-apartly from each other in the vertical plane. The sheets 112a/112b may be made, for example, of fiber glass without departing the scope of being made of other material having flexibility and strength enough to meet the industrial requirement. Further, the arm unit 110 may include a plurality of wires guides 113 that may be disposed within the spaced pair of sheets 112a/112b in spaced manner to provide additional rigidity to the structure. These wire guides 113 are disposed within the spaced pair of sheets 112 in spaced manner along the longitudinal direction of the sheets 112. The sheets 112 and wire guides 113 define the arm unit 110 that is flexible and thin in the lateral plane, and rigid and wide in a vertical plane, and which exhibits spring-like characteristics along its longitudinal axis. This enables the arm unit 110 to be pushed into a predefined shape of the external infrastructure, from the arm storage unit 102 by passively adapting its own shape in the lateral plane through its free end 110a.

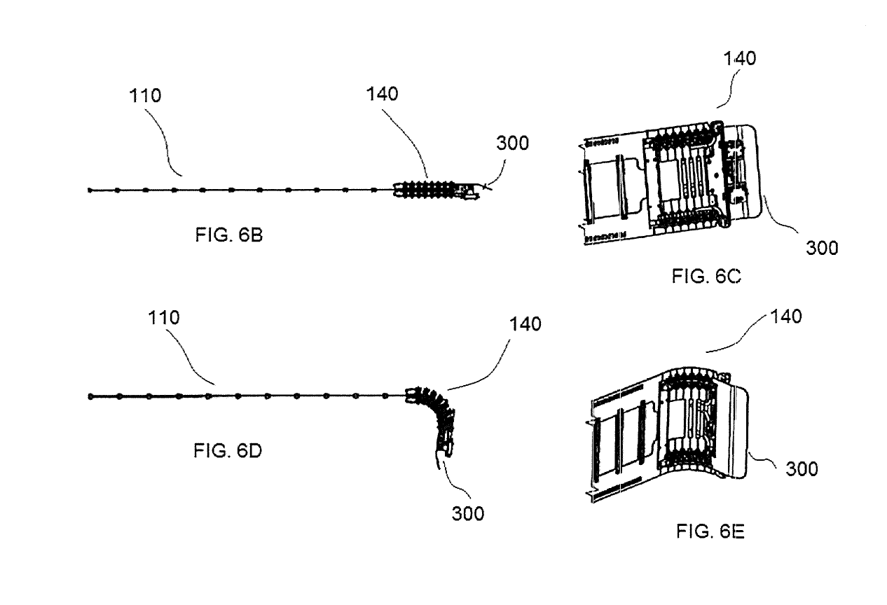

In one embodiment, the wire guides 113 may contain longitudinally extending rods having distal ends with holes (not shown for clarity). As per this embodiment, the wire guides 113 may incorporate wires, such as Bowden cables (not shown for clarity) passing through the holes to actuate the head articulation unit 140 to steer the non-actuated arm unit 110 by actively adapting its own shape in the lateral plane through its free end 110a. For that purpose, as shown in FIG. 6A, the head articulation unit 140 may include a flexible body 142 extending between opposite ends 143a, 143b. The opposite ends 143a, 143b respectively include upper and lower steering wires attachments 144a, 144b for actuating the flexible body 142 in a desired manner by actuating the wires 144a, 144b through the head articulation motors 141. Further, the flexible body 142 includes an interface end 144c coupled to a free end of the arm unit 110 through which wires pass to be coupled to the end tool 300. The steering wires attachments 144a, 144b with the wires couple the head articulation unit 140 with the head articulation motors 141 (see FIG. 4B) disposed in the main drive unit 101 to transmit mechanical movement from the head articulation motors 141 installed on the mounting structure 101 along the second level 104b to the head articulation unit 140. The head articulation unit 140 with the flexible body 142 and motor 141 may be capable of enabling steering or twisting movements (head-roll degree of freedom) of head articulation unit 140, and ultimately to move the end tool 300 in desired direction. By moving the head articulation motors 141 installed on the mounting structure 101 in same direction the steering is achieved while by moving the motors 141 in opposite directions head twisting is achieved. In addition, the wire guides 113 may also include electrical transmission cables (not shown for clarity) that may provide electrical data or power signals to motors and/or sensors embedded in the head articulation unit 140 and/or end-tool.

FIGS. 6B-6E illustrates various examples in which the unit 110 may be moved by the head articulation unit 140 that is driven by the at least one of the motor drive arrangements 141 configured in the mounting unit 101 to enable the end tool 300 towards the targeted area in the environment. FIGS. 6B and 6C respectively illustrate top and isometric views of the arm unit 140 and the end tool 300 when the head articulation unit 140 enables the arm unit 110 to move straight in forward to backward direction in the given confined environment. FIGS. 6C and 6D respectively illustrate top and isometric views of the arm unit 110 and the end tool 300 when the head articulation unit 300 enables the arm unit 110 to move left or right in the confined space environment.

Referring now to FIGS. 7A to 10B, another embodiment of the robotic system 10 is described. The main drive unit 200 of this embodiment, similar to above, includes a mounting structure 201 and the arm storage unit 202 coupled to the mounting structure 201. The mounting structure 201 includes a plurality of plates 203a arranged in relation to each other to form first and 204a second 204b levels within the main drive unit 200 to accommodate the arm storage unit 202 in the first level 204a. The mounting structure of this embodiment also includes casing arrangement 205 for covering the first and second levels 204a, 204b. Further, the arm storage unit 202 coupled to the mounting structure 201 is positioned in the first level 204a. As seen in FIG. 7B, the arm storage unit 202 may include spiral grooves 202a engraved in the upper and lower plates 203a to store the arm unit 210 therealong.

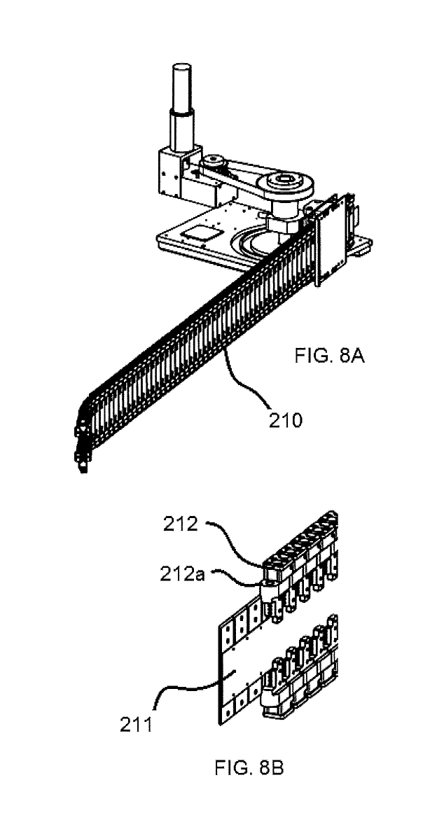

Furthermore, the axial drive unit 220, as seen FIGS. 9A-9B as described in conjunction to FIGS. 7A-8C, may be coupled to plates 203a outside of the mounting structure 201 and extend in the mounting structure 201 along the second level 204b to enable the arm unit 210 to axially extend and contract from the arm storage unit 202 along the direction defined by the arm guidance member 230. The axial drive unit 220 as per this embodiment may include an axial drive motor 221, an axial drive gear and belt arrangement 222 coupled with a gear box 222a, and an arm attachment 223. The axial drive gear and belt arrangement 222 is driven by the axial drive motor 221 with the help of gear box 222a. The arm attachment 223 may be coupled to the arm unit 210 to drive the arm unit 210.

Further, the arm guidance member 230 may be coupled to the plates 203a along the first level 204a to guide the arm unit 210 in a predefined direction in the lateral plane during axial extension and retraction of the arm unit 210 from the arm storage unit 202 with respect to the mounting structure 201. In one example arrangement, as shown in FIG. 9A, the arm guidance member 230 may be coupled along a side portion 230c of the first level 204a to guide the arm unit 210. As per this arrangement, the arm guidance member 230 includes a set of two plates 231 arranged vertically and in spaced manner from each other. Through the spaced plates 231, the arm unit 210 is advanced to expand or contract from and on the arm storage unit 202 and supported by a set of arm guidance member 230.

Furthermore, the arm unit 210 (seen in FIGS. 8A-8B) of this embodiment may include a sheet structure 211 embedded a plurality of mechanical segments 212. The sheet 211 may be made, for example, of spring steel without departing the scope of being made of other material having flexibility and strength enough to meet the industrial requirement. The flexible sheet 211 extends in the lateral plane and the various mechanical segments 212 coupled by mechanical joints 212a are mounted laterally along the sheet 211 to obtain the arm unit 210. As in the first described embodiment, the arm unit 210 also flexible and thin in the lateral plane, and rigid and wide in a vertical plane, exhibits spring-like characteristics along its longitudinal axis to be pushed from the arm storage unit 202 into a predefined shape of an external infrastructure, by passively adapting its own shape in the lateral plane.

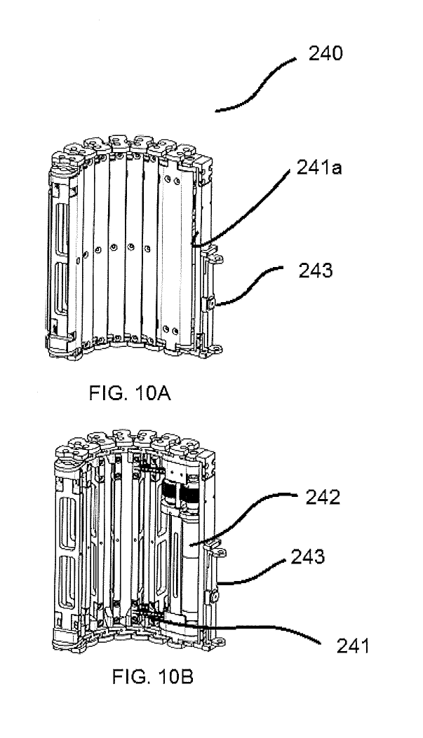

The head articulation unit 240, as seen FIGS. 10A-10C and as described in conjunction with FIGS. 7A-9C, may be configured to the arm unit 210. The head articulation unit 240 may include a steering chain arrangement 241, a steering motor 242 and a head roll joint 243. The head articulation unit 240 includes an interface end 241a coupled to a free end of the arm unit 210. The steering motor 242 is installed in the head articulation unit 240. Further, the steering motor 242 is coupled to the steering chain arrangement 241 to actuate the steering chain 241. The steering chain arrangement 241 may extend from the steering motor 242 of the head articulation unit 240 to the tip of the head articulation unit 240.

Referring now to FIGS. 11A and 11B, the robotic system 10 may further include various kinds of end tools 300 depending as per the requirement and nature of the job to be carried out by the robotic system 10. In the context of this disclosure, the robotic system 10 may be utilized for the purpose of inspection and will be described accordingly, without departing from the scope of being utilized for other applications. For the purpose of inspection, the end tool 300 may be an exchangeable inspection scanner 300. The exchangeable inspection scanner 300 may be configured to the head articulation unit 140, 240 to scan a specific surface area in a given confined space environment using methods such as ultrasound or eddy current inspection. In an example embodiment, as shown in FIG. 11A, the exchangeable inspection scanner 300 may include a spreading mechanism 310, a back skid 311, a probe holder 312, and a linear guidance 314. The spreading mechanism 310 may be coupled to the head articulation unit 140, 240. The back skid 311 may be coupled to the spreading mechanism 310 at one side and the probe holder 312 may be coupled to the spreading mechanism 310 on other side opposite to the back skid 311. The probe holder 312 is capable of holding at least one measurement probe 312a, for example for non-destructive testing. Further, the linear guidance 314 may be coupled to the probe holder 312 to guide the probe holder 312 and probes 312a linearly along the linear guidance 314. The spreading mechanism 310 enables the probe holder 312 and probes 312a to extend transversely in to the structure for inspection as for example between the opposing airfoils of gas turbine blades.

In one embodiment, the end tool 300 may be an exchangeable camera system 316 mounted to the head articulation unit 140, 240 for the purpose of visual inspection, such exchangeable camera system 316 may include an interface 316a for the camera to be coupled to the head articulation unit 140, 240.

In one embodiment, the mounting structure 101, 202 may further includes a plurality of electronic components (not shown) mounted on the mounting structure 101, 202 to enable operations including at least an electric power distribution, sensor data acquisition, motor control function, communication between a plurality of devices. The electronic components may be disposed in the mounting structure 101, 202 in the second level 104b, 204b. In one embodiment, various wiring arrangements (not shown) are configured to respective units to electrically transmit data signals and electric power along the respective unit.

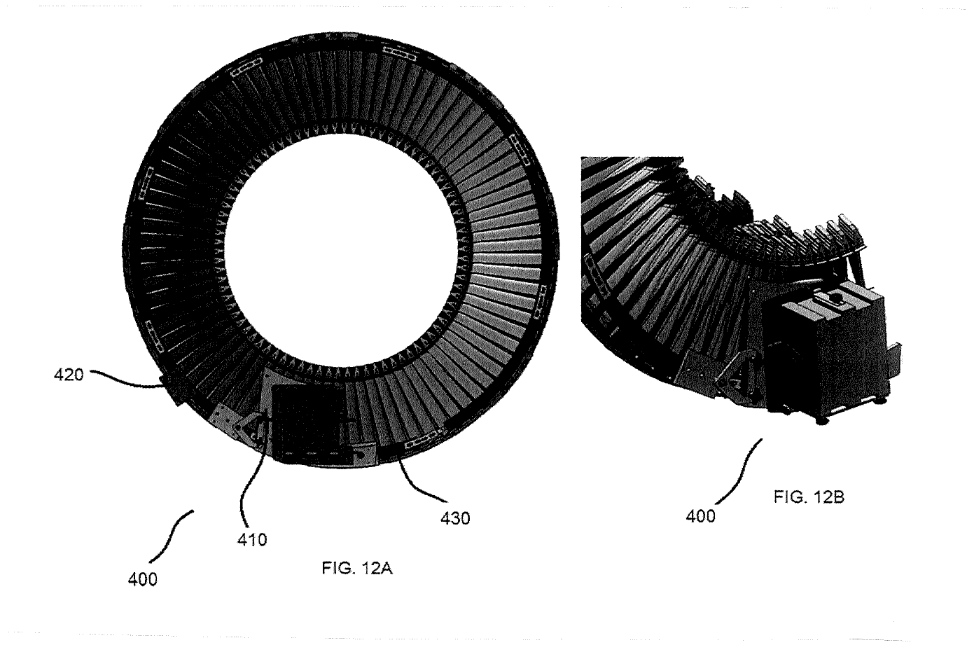

As shown in FIGS. 12A and 12B, the robotic system 10 may further include a carrier platform 400 to mount the main drive unit 100, 200 thereon to move the main drive unit 100, 200 along a predefined path. The carrier platform 400 may include a carrier plate 410, a driving motor 420, and a guidance member 430. The carrier plate 410 may be adapted to mount the main drive unit 100, 200 thereon. The driving motor 420 may be coupled to the carrier plate 400 to drive the carrier platform 410. The guidance member 430 is coupled to the carrier plate 410 to guide the main drive unit 100, 200 along the predefined path. The carrier platform 400 may be driven in a direction, such as linear direction, circular direction or omnidirectional as per the need, depending upon an environment in which the robotic system 10 may be used. For example, if the carrier platform 400 is moved in a circular direction along the circumference of an object, the main drive unit 100, 200 installed on the carrier platform 400 moves a with the a platform 400 along the given circular path.

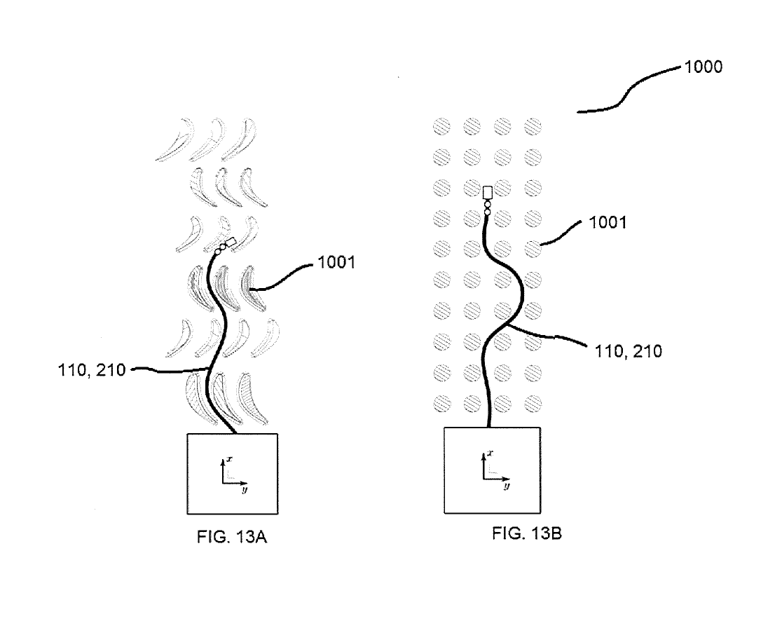

FIGS. 13A and 13B depict an environment 1000 where the robotic system 10 of the present disclosure may be utilized for the purpose of inspection. The environment 1000 may be turbine blades 1001 along the rotor and stator of a gas turbine where the robotic system 10 may be used for inspection purposes. However, without departing from the scope of the present disclosure, there may be other environments where the robotic system 10 may be utilized as per the requirement.

While the disclosure has been described in terms of preferred embodiments, those skilled in the art will recognize that the invention can be practiced with modification within the spirit and scope of the appended claims.

### REFERENCE NUMERAL LIST

10 Robotic system
100, 200 Main drive unit
101, 201 Mounting structure
102, 202 Arm storage unit
103a, 203a Plates
103b Poles
104a, 204a First level
104b, 204b Second level
105 Opening
205 Casing arrangement
110, 210 Non-actuated extendable arm unit
110a, 210a Free end
111, 211 Flexible sheet arrangement
112 Elongated structure
112a, 112b Pair of flat flexible sheet elements
113 Wires guides
211 Flexible elongated sheet
212 Mechanical joints
120, 220 Axial drive unit
121 Axial drive motor
122 Axial drive tower pinion and spring arrangement
123 Arm attachment
221 Axial drive motor
222 Axial drive gear and belt arrangement
222a Gear box
223 Arm attachment
130, 230 Arm guidance member
131 Rollers
230c Side portion
231 Set of two plates
140, 240 Head articulation unit
141 Head articulation motors
142 Flexible body
143a, 143b Opposite ends
144a, 144b Upper and lower steering wires attachments
144c Interface end
241 Steering chain arrangement
242 Steering motor
243 Head roll joint
241a Interface end
300 End tool, exchangeable scanner
310 Spreading mechanism
311 Back skid
312 Probe holder
312a Probes
314 Linear guidance
316 Exchangeable camera system
316a Interface
400 Carrier platform
410 Carrier plate
420 Driving motor
430 Guidance member
1000 Environment
1001 Turbine blades

1. A robotic system, comprising:
a main drive unit having a mounting structure, and an arm storage unit coupled to the mounting structure;
a non-actuated extendable arm unit coupled to the arm storage unit and configured to be moved axially in a predefined direction in a lateral plane from the arm storage unit, the non-actuated extendable arm unit having an elongated structure flexible and thin in the lateral plane relative to the vertical plane and rigid and wide in a vertical plane relative to the lateral plane;
an axial drive unit coupled to the arm storage unit and configured to axially extend and retract the non-actuated extendable arm unit from the arm storage unit;
an arm guidance member coupled to the arm storage unit to guide the non-actuated extendable arm unit in a predefined direction in the lateral plane during extension and retraction; and
a head articulation unit coupled to a free end of the non-actuated extendable arm unit and configured to actuate and move the non-actuated extendable arm unit in varying directions in confined spaces and environments.

2. A robotic system as claimed in claim 1, comprising:
a carrier platform to mount the main drive unit thereon and configured to move the main drive unit along a predefined path, wherein the carrier platform includes:
a carrier plate configured to mount the main drive unit thereon;
a driving motor coupled to the carrier plate and configured to drive the carrier platform; and
a guidance member coupled to the carrier plate and configured to guide the main drive unit along the predefined path.

3. The robotic system as claimed in claim 1, wherein the mounting structure comprises:
a plurality of plates and poles arranged in relation to each other to form first and second levels within the main drive unit to accommodate the arm storage unit extending across the first and second levels, and wherein the axial drive unit is disposed in the first level of the mounting structure to enable the non-actuated extendable arm unit to axially extend and retract from the arm storage unit along the direction defined by the arm guidance member.

4. The robotic system as claimed in claim 3, wherein the axial drive unit comprises:
an axial drive motor; and
an axial drive tower pinion and spring arrangement configured to be driven by the axial drive motor to axially expand and contract the non-actuated extendable arm unit; and
an arm attachment coupled to the axial drive tower pinion and spring arrangement and configured to axially guide the non-actuated extendable arm unit, wherein the arm guidance member is coupled to the plates along the first level to guide the non-actuated extendable arm unit in a predefined direction in the lateral plane during axial extension and retraction of the non-actuated extendable arm unit from the arm storage unit with respect to the mounting structure.

5. The robotic system as claimed in claim 1, wherein the non-actuated extendable arm unit comprises:
an elongated structure having a pair of flat flexible sheets elements oriented spaced-apartly from each other in lateral plane; and
a plurality of wire guides vertically positioned within the spaced pair of flat flexible sheet elements in spaced manner in the lateral plane to obtain the non-actuated extendable arm unit flexible and thin in the lateral plane, and rigid and wide in a vertical plane to exhibit spring-like characteristics along its longitudinal axis so as to be configurable into a predefined shape of an external infrastructure, from the arm storage unit by a passively adapting its own shape in the lateral plane.

6. The robotic system as claimed in claim 1, wherein the head articulation unit comprises:
a flexible body extending between opposite ends, the flexible body having an interface end coupled to the free end of the non-actuated extendable arm unit; and
a plurality of wires to couple the head articulation unit with a head articulation motor positioned within the main drive unit.

7. The robotic system as claimed in claim 1, wherein the mounting structure comprises:
a plurality of plates arranged in relation to each other to form first and second levels within the main drive unit to accommodate the arm storage unit in the first level; and
a casing arrangement covering the first and second levels.

8. The robotic system as claimed in claim 7, wherein the arm guidance member is coupled to the plates along the first level and configured to guide the non-actuated extendable arm unit in a predefined direction in the lateral plane while axial extension and retraction of the non-actuated extendable arm unit from the arm storage unit with respect to the mounting structure; and
wherein the axial drive unit is coupled to plates outside of the mounting structure and extends in the mounting structure along the second level to enable the non-actuated extendable arm unit to axially extend and retract from the arm storage unit along the direction defined by the arm guidance member.

9. The robotic system as claimed in claim 8, wherein the axial drive unit comprises:
an axial drive motor;
an axial drive gear and belt arrangement arranged to be driven by the axial drive motor; and
an arm attachment coupled to the axial drive gear and belt arrangement to be driven to axially guide the non-actuated extendable arm unit, wherein the arm attachment is coupled to the non-actuated extendable arm unit.

10. The robotic system as claimed in claim 8, wherein the arm guidance member is coupled along a side portion of the first level and configured to guide the non-actuated extendable arm unit in a predefined direction in the lateral plane during axial extension and retraction of the non-actuated extendable arm unit from the arm storage unit with respect to the mounting structure.

11. The robotic system as claimed in claim 1, wherein the non-actuated extendable arm unit comprises:
a flexible elongated sheet disposed in the lateral plane to obtain the non-actuated extendable arm unit flexible and thin in the lateral plane; and
a plurality of mechanical segments, connected by mechanical joints, in series, and positioned along the lateral side edges of the flexible sheet to obtain the non-actuated extendable arm unit rigid and wide in the vertical plane to be configured into a predefined shape of an external infrastructure, from the arm storage unit by passively adapting its own shape in the lateral plane.

12. The robotic system as claimed in claim 11, wherein the head articulation unit comprises:
an interface end coupled to the free end of the non-actuated extendable arm unit, the head articulation unit including:
a steering chain arrangement extending across the mechanical segments of the head articulation unit by passing through the mechanical segments and joints;
a steering motor coupled to the steering chain arrangement and configured to actuate the steering chain arrangement non-actuated; and
a head roll joint having a rotational degree of freedom, and coupled to the steering chain arrangement.

13. The robotic system as claimed in claim 1, comprising:
an end tool attached to the head articulation unit.

14. The robotic system as claimed in claim 13, the end tool comprising:
an exchangeable inspection scanner having:
a spreading mechanism coupled to the head articulation unit;
a back skid coupled to the spreading mechanism at one side;
a probe holder having at least one probe the probe holder coupled to the spreading mechanism on other side opposite to the back skid; and
a linear guidance coupled to the probe holder and configured to guide the probe holder and probes.

15. The robotic system as claimed in claim 14, wherein the end tool is an exchangeable camera system mounted to the head articulation unit for the purpose of visual inspection and comprising:
an interface for the camera system to be coupled to the head articulation unit.
